(19) United States
(12) Patent Application Publication
(10) Pub. No.: US 2003/0040457 A1
(43) Pub. Date: Feb. 27, 2003

(54) Surfactant granulates

(76) Inventors: Ansgar Behler, Bottrop (DE); Norbert Huebner, Langenfeld (DE); Alfred Westfechtel, Hilden (DE)

Correspondence Address: COGNIS CORPORATION, 2500 RENAISSANCE BLVD., SUITE 200, GULPH MILLS, PA, 19406

(21) Appl. No.: 10/182,974

(22) PCT Filed: Jan. 25, 2001
(86) PCT No.: PCT/EP01/00788

(30) Foreign Application Priority Data
Feb. 3, 2000 (DE) 10004678.9

(51) Int. Cl. C11D 17/00

(52) U.S. Cl. 510/421; 510/446; 510/426

(57) ABSTRACT

The invention relates to surfactant granulates containing fatty alcohol oxylates, obtained by alkoxylating plant based fatty alcohols and anionic surfactants and, optionally, other non-ionic surfactants and dispersing agents. The invention also relates to methods for the production of the inventive surfactant granulates and the use thereof in washing, rinsing and cleaning agents.

### FIELD OF THE INVENTION

This invention relates to surfactant granules containing fatty alcohol alkoxylates obtainable by alkoxylation of fatty alcohols of vegetable origin and anionic surfactants and optionally other nonionic surfactants and disintegrators, to processes for producing the surfactant granules according to the invention and to their use in laundry detergents, dishwashing detergents and cleaning compositions.

### PRIOR ART

For the production of laundry detergents, dishwashing detergents and cleaning compositions, surfactants are preferably used in granular form. Surfactant granules are particularly easy to process and store and are distinguished by their low dust content which makes processing safer. Modern detergent formulations always contain mixtures of anionic and nonionic surfactants for optimally combating various soils. However, on account of the vigorous foaming associated with the use of anionic surfactants, corresponding foam regulators have to be used. Unfortunately, this restricts the use of saturated, linear fatty alcohol ethoxylates, particularly at low washing temperatures of <40° C., because they tend to migrate into the defoamer granules, completely or at least partly deactivating the defoamer in the process. The required foaming behavior of the preparation is thus no longer achieved.

EP 0 370 273 B1 (Henkel) describes the production of fatty alcohol mixtures with a particular specification from purely vegetable oils or fats, their ethoxylation and their use as a surfactant component.

The problem addressed by the present invention was to provide surfactant mixtures which would dissolve quickly and which would develop a very high washing and cleaning performance, even at 30° C. At the same time, deactivation of the defoamer would be avoided by the use of suitable surfactants. These properties are exhibited by surfactant granules which, besides conventional anionic surfactants, contain fatty alcohol alkoxylates based on vegetable, substantially unsaturated fatty alcohols. Surfactant granules containing conventional fatty alcohol ethoxylates may readily be replaced by the surfactant granules according to the invention in laundry detergents, dishwashing detergents and cleaning compositions.

By using fatty alcohol alkoxylates corresponding to formula (I), anionic surfactants and optionally other nonionic surfactants, enzymes and disintegrators, it is possible to produce surfactant granules which satisfy all the requirements modern laundry detergents, dishwashing detergents and cleaning compositions are expected to meet. The solubility of the granules is greatly improved by the process used for their production. The surfactants and other ingredients can be released and activated particularly quickly.

### DESCRIPTION OF THE INVENTION

The present invention relates to surfactant granules containing

a. fatty alcohol alkoxylates corresponding to formula (I) based on vegetable unsaturated fatty alcohols with iodine values of 20 to 130 and a conjuene content of less than 4.5% by weight:

R¹—O(CH₂R²CHO)ₓ—H (I)

in which

R¹ is an alkenyl group containing 6 to 22 carbon atoms.

R² is hydrogen or a methyl or ethyl group and

x has a value of 1 to 50, and

b. anionic surfactants.

Fatty Alcohol Alkoxylates Based on Vegetable Fatty Alcohols

The surfactant granules according to the invention contain fatty alcohol alkoxylates corresponding to formula (I) obtainable by pressure hydrolysis of vegetable fats and oils into fatty acids or by subsequent esterification or direct transesterification with methanol into the fatty acid methyl esters and subsequent selective hydrogenation to fatty alcohols with the double bonds intact and subsequent alkoxylation, preferably ethoxylation. Fatty alcohol ethoxylates are produced by ethoxylation of vegetable fatty alcohols R¹—OH as described in EP 370 273 B1.

The alkenyl group R¹ may be derived from primary unsaturated alcohols. Typical examples of unsaturated alcohols are undecen-1-ol, lauroleic alcohol, myristoleic alcohol, palmitoleic alcohol, petroselaidic alcohol, oleyl alcohol, elaidyl alcohol, ricinolyl alcohol, linoleyl alcohol, linolenyl alcohol, gadoleyl alcohol, arachidonic alcohol, erucic alcohol, brassidyl alcohol, palmitoleyl alcohol, petroselinyl alcohol, arachyl alcohol and mixtures thereof and mixtures of unsaturated and saturated fatty alcohols obtained by the process described in EP 0 724 555 B1.

The vegetable fatty alcohols are compounds of which a large part, i.e. at least 10% by weight, is unsaturated and which have iodine values of 20 to 130, preferably 20 to 110 and more particularly 20 to 85 and a conjuene content of less than 4.5% by weight and preferably below 6% by weight.

Fatty alcohol alkoxylates derived from monohydric unsaturated C₆₋₂₂ and more particularly C₆₋₁₈ alcohols with the formula R¹—OH are also preferred for the purposes of the invention.

The fatty alcohols are used in the form of their alkoxylates which are obtained by reaction with 1 to 50 mol, preferably 2 to 35 mol and more particularly 3 to 25 mol of 1,2-epoxyalkanes CH₂OCHR², where R² is hydrogen or a methyl or ethyl group. Fatty alcohol ethoxylates (R²=hydrogen) obtained by reaction with 1 to 50 mol, preferably 2 to 35 mol and more particularly 3 to 25 mol of ethylene oxide are preferably used. Fatty alcohol ethoxylates with a degree of ethoxylation of 50 to 60% by weight ethylene oxide are particularly preferred.

The alkoxylation is carried out in the presence of catalysts, preferably alkaline catalysts, such as sodium methanolate, sodium hydroxide and potassium hydroxide.

In a preferred embodiment, the surfactant granules according to the invention contain 0.1 to 89% by weight, preferably 0.2 to 85% by weight and more particularly 0.5 to 70% by weight, based on the granules, of fatty alcohol alkoxylates corresponding to formula (I), expressed as active substance.

The active substance content is calculated on the basis that all components are present as pure substances.

Anionic Surfactants

The surfactant granules according to the invention contain anionic surfactants as a compulsory component. Typical examples of anionic surfactants are soaps, alkyl benzenesulfonates, secondary alkane sulfonates, olefin sulfonates, alkyl ether sulfonates, glycerol ether sulfonates, α-methyl ester sulfonates, sulfofatty acids, alkyl and/or alkenyl sulfates, alkyl ether sulfates, glycerol ether sulfates, hydroxy mixed ether sulfates, fatty alcohol (ether) phosphates, monoglyceride (ether) sulfates, fatty acid amide (ether) sulfates, mono- and dialkyl sulfosuccinates, mono- and dialkyl sulfosuccinamates, sulfotriglycerides, amide soaps, ether carboxylic acids and salts thereof, fatty acid isethionates, fatty acid sarcosinates, fatty acid taurides, N-acylamino acids such as, for example, acyl lactylates, acyl tartrates, acyl glutamates and acyl aspartates, alkyl oligoglucoside sulfates, protein fatty acid condensates (particularly wheat-based vegetable products) and alkyl (ether) phosphates. If the anionic surfactants contain polyglycol ether chains, the polyglycol ether chains may have a conventional homolog distribution, although they preferably have a narrow homolog distribution.

Alkyl and/or alkenyl sulfates, alkyl ether sulfates, alkyl benzenesulfonates, soaps, monoglyceride (ether) sulfates and alkanesulfonates, more particularly fatty alcohol sulfates, fatty alcohol ether sulfates, secondary alkanesulfonates and linear alkyl benzenesulfonates are preferably used as anionic surfactants.

The surfactant granules according to the invention preferably contain 0.1 to 89% by weight, preferably 0.2 to 85% by weight and more particularly 0.5 to 70% by weight, based on the granules, of anionic surfactants, expressed as active substance.

Alkyl and/or Alkenyl Sulfates

Alkyl and/or alkenyl sulfates, which are often also referred to as fatty alcohol sulfates, are understood to be the sulfation products of primary alcohols which correspond to formula (II):

R³O—SO₃X (II)

in which R³ is a linear or branched, aliphatic alkyl and/or alkenyl group containing 6 to 22 carbon atoms and preferably 12 to 18 carbon atoms and X is an alkali metal and/or alkaline earth metal, ammonium, alkyl ammonium, alkanolammonium or glucammonium. Typical examples of alkyl sulfates which may be used in accordance with the invention are the sulfation products of caproic alcohol, caprylic alcohol, capric alcohol, 2-ethyl hexyl alcohol, lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol and erucyl alcohol and the technical mixtures thereof obtained by high-pressure hydrogenation of technical methyl ester fractions or aldehydes from Roelen's oxo synthesis. The sulfation products may advantageously be used in the form of their alkali metal salts and particularly their sodium salts. Alkyl sulfates based on C_{16/18} tallow fatty alcohols or vegetable fatty alcohols of comparable C chain distribution in the form of their sodium salts are particularly preferred.

Alkyl Ether Sulfates

Alkyl ether sulfates (“ether sulfates”) are known anionic surfactants which, on an industrial scale, are produced by SO₃ or chlorosulfonic acid (CSA) sulfation of fatty alcohol or oxoalcohol polyglycol ethers and subsequent neutralization. Ether sulfates suitable for use in accordance with the invention correspond to formula (III):

R⁴O—(CH₂CH₂O)ₐSO₃X (III)

in which R⁴ is a linear or branched alkyl and/or alkenyl radical containing 6 to 22 carbon atoms, a is a number of 1 to 10 and X is an alkali metal and/or alkaline earth metal, ammonium, alkylammonium, alkanolammonium or glucammonium. Typical examples are the sulfates of addition products of on average 1 to 10 and more particularly 2 to 5 mol of ethylene oxide onto caproic alcohol, caprylic alcohol, 2-ethylhexyl alcohol, capric alcohol, lauryl alcohol, isotridecyl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol and brassidyl alcohol and technical mixtures thereof in the form of their sodium and/or magnesium salts. The ether sulfates may have both a conventional homolog distribution and a narrow homolog distribution. It is particularly preferred to use ether sulfates based on adducts of on average 2 to 3 mol ethylene oxide with technical C_{12/14} or C_{12/18} coconut fatty alcohol fractions in the form of their sodium and/or magnesium salts.

Alkyl Benzenesulfonates

Alkyl benzenesulfonates preferably correspond to formula (IV):

R⁵—Ph—SO₃X (IV)

in which R⁵ is a branched, but preferably linear alkyl group containing 10 to 18 carbon atoms, Ph is a phenyl group and X is an alkali metal and/or alkaline earth metal, ammonium, alkyl ammonium, alkanolammonium or glucammonium. Dodecyl benzenesulfonates, tetradecyl benzenesulfonates, hexadecyl benzenesulfonates and technical mixtures thereof in the form of the sodium salts are preferably used.

Soaps

Finally, soaps are understood to be fatty acid salts corresponding to formula (V):

R⁶CO—OX (V)

in which R⁶CO is a linear or branched, saturated or unsaturated acyl group containing 6 to 22 and preferably 12 to 18 carbon atoms and X is alkali and/or alkaline earth metal, ammonium, alkylammonium or alkanolammonium. Typical examples are the sodium, potassium, magnesium, ammonium and triethanolammonium salts of caproic acid, caprylic acid, 2-ethylhexanoic acid, capric acid, lauric acid, isotridecanoic acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid and technical mixtures thereof. Coconut oil fatty acid or palm kernel oil fatty acid in the form of their sodium or potassium salts are preferably used.

Monoglyceride (Ether)Sulfates

Monoglyceride sulfates and monoglyceride ether sulfates are known anionic surfactants which may be obtained by the relevant methods of preparative organic chemistry. They are normally produced from triglycerides by transesterification to the monoglycerides, optionally after ethoxylation, followed by sulfation and neutralization. The partial glycerides may also be reacted with suitable sulfating agents, preferably gaseous sulfur trioxide or chlorosulfonic acid [cf. EP 0 561 825 B1, EP 0 561 999 B1 (Henkel)]. If desired, the neutralized products may be subjected to ultrafiltration to reduce the electrolyte content to a desired level [DE 42 04 700 A1 (Henkel)]. Overviews of the chemistry of monoglyceride sulfates have been published, for example, by A. K. Biswas et al. in J. Am. Oil. Chem. Soc. 37, 171 (1960) and by F. U. Ahmed in J. Am. Oil. Chem. Soc. 67, 8 (1990). The monoglyceride (ether)sulfates suitable for the purposes of the invention correspond to formula (VI):

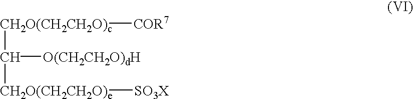

in which R⁷CO is a linear or branched acyl group containing 6 to 22 carbon atoms, c, d and e together stand for 0 or numbers of 1 to 30 and preferably 2 to 10 and X is an alkali metal or alkaline earth metal. Typical examples of monoglyceride (ether)sulfates suitable for the purposes of the invention are the reaction products of lauric acid monoglyceride, coconut fatty acid monoglyceride, palmitic acid monoglyceride, stearic acid monoglyceride, oleic acid monoglyceride and tallow fatty acid monoglyceride and ethylene oxide adducts thereof with sulfur trioxide or chlorosulfonic acid in the form of their sodium salts. Monoglyceride sulfates corresponding to formula (VI), in which R⁷CO is a linear acyl group containing 8 to 18 carbon atoms, are preferably used.

Alkanesulfonates

Alkane sulfonates may be divided into primary and secondary alkanesulfonates. These are understood to be compounds corresponding to formula (VII):

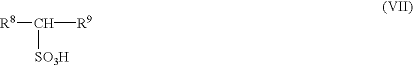

where—in the case of primary alkanesulfonates—R⁸ is hydrogen and R⁹ is an alkyl group containing no more than 50 carbon atoms. Secondary alkanesulfonates are preferred. R⁸ and R⁹ stand for alkyl groups and, together, should contain no more than 50 carbon atoms.

In a preferred embodiment, the surfactant granules according to the invention contain fatty alcohol alkoxylates corresponding to formula (I) and anionic surfactants in a ratio by weight of 1:90 to 90:1, preferably 1:50 to 50:1 and more particularly 1:10 to 10:1.

The surfactant granules preferably contain fatty alcohol alkoxylates of formula (I) and anionic surfactants, expressed as active substance, in quantities of 0.1 to 89% by weight, preferably 0.2 to 85% by weight and more particularly 0.5 to 70% by weight, based on the granules. The active substance is calculated on the basis that all components are present as pure substances.

Nonionic Surfactants

The surfactant granules according to the invention may contain other nonionic surfactants. Typical examples of other nonionic surfactants are alkoxylates of alkanols, end-capped alkoxylates of alkanols with no free OH groups, alkoxylated fatty acid lower alkyl esters, hydroxy mixed ethers, alkylphenol polyglycol ethers, fatty acid polyglycol esters, fatty acid amide polyglycol ethers, fatty amine polyglycol ethers, alkoxylated triglycerides, mixed ethers and mixed formals, alk(en)yl oligoglycosides, fatty acid-N-alkyl glucamides, protein hydrolyzates (more particularly wheat-based vegetable products), polyol fatty acid esters, sugar esters, sorbitan esters, polysorbates and amine oxides. If the nonionic surfactants contain polyglycol ether chains, they may have a conventional homolog distribution although they preferably have a narrow homolog distribution.

The other nonionic surfactants are preferably selected from the group consisting of alkyl and/or alkenyl oligoglycosides, hydroxy mixed ethers, alkoxylates of alkanols, more particularly fatty alcohol polyethylene glycol/polypropylene glycol ethers (FAEO/PO) or fatty alcohol polypropylene glycol/polyethylene glycol ethers (FAPO/EO), end-capped alkoxylates of alkanols, more particularly end-capped fatty alcohol polyethylene glycol/polypropylene glycol ethers or end-capped fatty alcohol polypropylene glycol/polyethylene glycol ethers, and fatty acid lower alkyl esters and amine oxides.

Alkyl and/or Alkenyl Oligoglycosides

Alkyl and/or alkenyl oligoglycosides corresponding to formula (VIII):

R¹⁰O—[G]ₚ (VIII)

are preferably used. In formula (VIII), R¹⁰ is an alkyl and/or alkenyl group containing 4 to 22 carbon atoms, G is a sugar unit containing 5 or 6 carbon atoms and p is a number of 1 to 10. They may be obtained by the relevant methods of preparative organic chemistry. EP 0 301 298 A1 and WO 90/03977 are cited as representative of the extensive literature available on the subject. The alkyl and/or alkenyl oligoglycosides may be derived from aldoses or ketoses containing 5 or 6 carbon atoms, preferably glucose. Accordingly, the preferred alkyl and/or alkenyl oligoglycosides are alkyl and/or alkenyl oligoglucosides. The index p in general formula (VIII) indicates the degree of oligomerization (DP), i.e. the distribution of mono- and oligoglycosides, and is a number of 1 to 10. Whereas p in a given compound must always be an integer and, above all, may assume a value of 1 to 6, the value p for a certain alkyl oligoglycoside is an analytically determined calculated quantity which is generally a broken number. Alkyl and/or alkenyl oligoglycosides having an average degree of oligomerization p of 1.1 to 3.0 are preferably used. Alkyl and/or alkenyl oligoglycosides having a degree of oligomerization of less than 1.7 and, more particularly, between 1.2 and 1.4 are preferred from the applicational point of view. The alkyl or alkenyl radical R¹⁰ may be derived from primary alcohols containing 4 to 11 and preferably 8 to 10 carbon atoms. Typical examples are butanol, caproic alcohol, caprylic alcohol, capric alcohol and undecyl alcohol and the technical mixtures thereof obtained, for example, in the hydrogenation of technical fatty acid methyl esters or in the hydrogenation of aldehydes from Roelen's oxosynthesis. Alkyl oligoglucosides having a chain length of C₈ to C₁₀ (DP=1 to 3), which are obtained as first runnings in the separation of technical C₈₋₁₈ coconut oil fatty alcohol by distillation and which may contain less than 6% by weight of C₁₂ alcohol as an impurity, and also alkyl oligoglucosides based on technical C_{9/11} oxoalcohols (DP=1 to 3) are preferred. In addition, the alkyl or alkenyl radical R¹⁰ may also be derived from primary alcohols containing 12 to 22 and preferably 12 to 14 carbon atoms. Typical examples are lauryl alcohol, myristyl alcohol, cetyl alcohol, palmitoleyl alcohol, stearyl alcohol, isostearyl alcohol, oleyl alcohol, elaidyl alcohol, petroselinyl alcohol, arachyl alcohol, gadoleyl alcohol, behenyl alcohol, erucyl alcohol, brassidyl alcohol and technical mixtures thereof which may be obtained as described above. Alkyl oligoglucosides based on hydrogenated C_{12/14} cocoalcohol with a DP of 1 to 3 are preferred.

Hydroxy Mixed Ethers

Hydroxy mixed ethers corresponding to formula (IX):

R¹¹O[CH₂CHR¹²O]_{b}[CH₂CHR¹³O]_{y}CR¹⁴HCH(OH)R¹⁵ (IX)

In formula (IX), R¹¹ is an alkyl and/or alkenyl group containing 4 to 22 carbon atoms, R¹² is hydrogen or a methyl or ethyl group, R¹³ is hydrogen or a methyl or ethyl group, R¹⁴ is hydrogen or an alkyl group containing 2 to 18 carbon atoms, R¹⁵ is an alkyl group containing 2 to 22 carbon atoms, b=0 or 1 to 30, y=0 or 1 to 30, x+y>=1.

Hydroxy mixed ethers corresponding to formula (IX) are known from the literature and are described, for example, in German patent application DE 19738866. Hydroxy mixed ethers may be ring opening products of both internal olefins (R¹⁴≠hydrogen) or terminal olefins (R¹⁴=hydrogen), the latter being preferred. They are prepared by reaction of 1,2-epoxyalkanes (R¹⁵CHOCR¹⁴H), where R¹⁴ is hydrogen, R¹⁵ is an aliphatic saturated, linear or branched alkyl group containing 2 to 22 and more particularly 6 to 16 carbon atoms, with alkoxylated alcohols.

Hydroxy mixed ethers preferred for the purposes of the invention are those derived from alkoxylates of monohydric alcohols with the formula R¹¹—OH containing 4 to 18 carbon atoms, R¹¹ being an aliphatic, saturated, linear or branched alkyl group, more particularly containing 6 to 16 carbon atoms. Examples of suitable straight-chain alcohols are butan-1-ol, caproic alcohol, oenanthic alcohol, caprylic alcohol, pelargonic alcohol, capric alcohol, undecan-1-ol, lauryl alcohol, tridecan-1-ol, myristyl alcohol, pentadecan-1-ol, palmityl alcohol, heptadecan-1-ol, stearyl alcohol, nonadecan-1-ol, arachidyl alcohol, heneicosan-1-ol, behenyl alcohol and the technical mixtures thereof obtained in the high-pressure hydrogenation of technical methyl esters based on fats and oils. Examples of branched alcohols are so-called oxo alcohols which generally contain 2 to 4 methyl groups as branches and are produced by the oxo process and so-called Guerbet alcohols which are branched in the 2-position by an alkyl group. Suitable Guerbet alcohols are 2-ethyl hexanol, 2-butyl octanol, 2-hexyl decanol and/or 2-octyl dodecanol.

The alcohols are used in the form of their alkoxylates which are prepared in known manner by reaction of the alcohols in any order with ethylene oxide, propylene oxide and/or butylene oxide. Alkoxylates of alcohols formed by reaction with 10 to 50 mol ethylene oxide (R¹², R¹³ and R¹⁴=hydrogen and b+y=1-50) are preferably used. Both alkoxylates obtained by reaction of alcohol with 1 to 10 mol propylene oxide (R¹²=methyl, b=1-10) and 10 to 30 mol ethylene oxide (R¹³=hydrogen, y=10-30) and those obtained by reaction of alcohol with 10 to 30 mol ethylene oxide (R¹²=hydrogen, b=10-30) and 1 to 10 mol propylene oxide (R¹³=methyl, y=1-10)—R¹⁴ being hydrogen in either case—are preferred.

Particularly suitable hydroxy mixed ethers are those corresponding to formula (IX), where R¹⁴ is hydrogen, R¹² is a methyl group and R¹³ is hydrogen, which have advantageously been produced by reaction of alcohol with 1 to 3 mol propylene oxide (b=1-3) and then with 10 to 25 mol ethylene oxide (y=10-25).

Fatty Alcohol Polyethylene Glycol/polypropylene Glycol Ethers

A preferred embodiment is characterized by the use of optionally end-capped fatty alcohol polyethylene glycol/polypropylene glycol ethers corresponding to formula (X):

R¹⁶O(CH₂CH₂O)ₙ[CH₂(CH₃)CHO]ₘR¹⁷ (X)

in which R¹⁶ is an alkyl and/or alkenyl group containing 8 to 22 carbon atoms, R¹⁷ is H or an alkyl group containing 1 to 8 carbon atoms, n is a number of 1 to 40, preferably 1 to 30 and more particularly 1 to 15 and m is 0 or a number of 1 to 10.

Fatty Alcohol Polypropylene Glycol/polyethylene Glycol Ethers

Optionally end-capped fatty alcohol polypropylene glycol/polyethylene glycol ethers corresponding to formula (XI):

R¹⁸O[CH₂(CH₃)CHO]_{q}(CH₂CH₂O)ᵣR¹⁹ (XI)

in which R¹⁸ is an alkyl and/or alkenyl group containing 8 to 22 carbon atoms, R¹⁹ is H or an alkyl group containing 1 to 8 carbon atoms, q is a number of 1 to 5 and r is a number of 0 to 15, are also suitable,

In a preferred embodiment, the mixtures according to the invention contain fatty alcohol polyethylene glycol/polypropylene glycol ethers corresponding to formula (X) in which R¹⁶ is an aliphatic saturated, linear or branched alkyl group containing 8 to 16 carbon atoms, n is a number of 1 to 10, m is 0 and R¹⁷ is hydrogen. These compounds (X) are products of the addition of 1 to 10 mol ethylene oxide onto monohydric alcohols. Suitable alcohols are the above-described alcohols, such as fatty alcohols, oxo alcohols and Guerbet alcohols. Other suitable alcohol ethoxylates are those which have a narrow homolog distribution.

Other suitable representatives of non-end-capped representatives are those corresponding to formula (X) in which R¹⁶ is an aliphatic, saturated, linear or branched alkyl group containing 8 to 16 carbon atoms, n is a number of 2 to 7, m is a number of 3 to 7 and R¹⁷ is hydrogen. These compounds (X) are products of the addition of monohydric alcohols of the type already described alkoxylated first with 2 to 7 mol ethylene oxide and then with 3 to 7 mol propylene oxide.

The end-capped compounds of formula (X) are terminated by a C₁₋₈ alkyl group (R¹⁷). In the literature, such compounds are also commonly referred to as mixed ethers. Suitable representatives are methyl-group-terminated compounds of formula (X) in which R¹⁶ is an aliphatic, saturated, linear or branched alkyl group containing 8 to 16 carbon atoms, n is a number of 2 to 7, m is a number of 3 to 7 and R⁷ is a methyl group. Compounds such as these may readily be prepared by reacting the corresponding non-end-capped fatty alcohol polyethylene glycol/polypropylene glycol ethers with methyl chloride in the presence of a base.

Other suitable representatives of alkyl-group-terminated compounds are those of formula (X), in which R¹⁶ is an aliphatic, saturated, linear or branched alkyl group containing 8 to 16 carbon atoms, n is a number of 5 to 15, m is 0 and R¹⁷ is an alkyl group containing 4 to 8 carbon atoms. The end capping is preferably carried out with a linear or branched butyl group by reacting the corresponding fatty alcohol polyethylene glycol ether with n-butyl chloride or with tert.butyl chloride in the presence of bases.

Optionally end-capped fatty alcohol polypropylene glycol/polyethylene glycol ethers of formula (XI) may be present instead of or in admixture with the compounds of formula (X). Compounds such as these are described, for example, in DE-A1-43 23 252. Particularly preferred representatives of the compounds of formula (XI) are those in which R¹⁸ is an aliphatic, saturated, linear or branched alkyl group containing 8 to 16 carbon atoms, q is a number of 1 to 5, r is a number of 1 to 6 and R¹⁹ is hydrogen. Compounds such as these are preferably products of the addition of 1 to 5 mol propylene oxide and 1 to 6 mol ethylene oxide onto monohydric alcohols which have already been described as suitable in connection with the hydroxy mixed ethers.

Alkoxylated Fatty Acid Lower Alkyl Esters

Suitable alkoxylated fatty acid lower alkyl esters are surfactants corresponding to formula (XII):

R²⁰CO—(OCH₂CHR²¹)_{w}OR²² (XII)

in which R²⁰CO is a linear or branched, saturated and/or unsaturated acyl group containing 6 to 22 carbon atoms, R²¹ is hydrogen or methyl, R²² represents linear or branched alkyl groups containing 1 to 4 carbon atoms and w is a number of 1 to 20. Typical examples are the formal insertion products of on average 1 to 20 and preferably 5 to 10 mol ethylene and/or propylene oxide into the methyl, ethyl, propyl, isopropyl, butyl and tert.butyl esters of caproic acid, caprylic acid, 2-ethylhexanoic acid, capric acid, lauric acid, isotridecanoic acid, myristic acid, palmitic acid, palmitoleic acid, stearic acid, isostearic acid, oleic acid, elaidic cid, petroselic acid, linoleic acid, linolenic acid, elaeostearic acid, arachic acid, gadoleic acid, behenic acid and erucic acid and technical mixtures thereof. Normally, the products are obtained by insertion of the alkoxides into the carbonyl ester bond in the presence of special catalysts such as, for example, calcined hydrotalcite. Reaction products of on average 5 to 10 mol ethylene oxide into the ester bond of technical coconut fatty acid methyl esters are particularly preferred.

Amine Oxides

Compounds corresponding to formula (XIII) and/or (XIV):

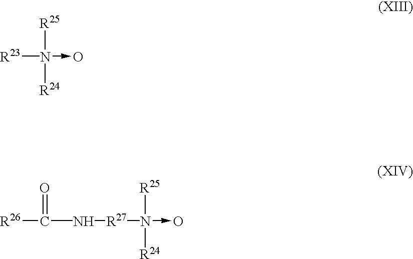

may be used as amine oxides. The amine oxides corresponding to formula (XIII) are produced by oxidation of tertiary fatty amines having an least one long alkyl chain in the presence of hydrogen peroxide. In the amine oxides of formula (XIII) suitable for the purposes of the invention, R²³ is a linear or branched alkyl chain containing 6 to 22 and preferably 12 to 18 carbon atoms and R²⁴ and R²⁵ independently of one another have the same meaning as R²³ or represent an optionally hydroxysubstituted alkyl group containing 1 to 4 carbon atoms. Preferred amine oxides of formula (XIII) are those in which R²³ and R²⁴ represent C_{12/14} or C_{12/18} coconut alkyl groups and R²⁵ is a methyl or hydroxyethyl group. Other preferred amine oxides of formula (XIII) are those in which R²³ is a C_{12/14} or C_{12/18} coconut alkyl group and R²⁴ and R²⁵ represent a methyl or hydroxyethyl group. Other suitable amine oxides are alkylamidoamine oxides corresponding to formula (XIV) where the alkylamido group R²⁶CONH is formed by the reaction of linear or branched carboxylic acids preferably containing 6 to 22 and more particularly 12 to 18 carbon atoms, more particularly from C_{12/14} or C_{12/18} fatty acids, with amines. R²⁷ is a linear or branched alkenyl group containing 2 to 6 and preferably 2 to 4 carbon atoms and R²⁴ and R²⁵ are as defined for formula (XIII).

In a preferred embodiment, the surfactant granules according to the invention contain 0.1 to 89% by weight, preferably 0.2 to 85% by weight and more particularly 0.5 to 70% by weight, based on the granules, of other nonionic surfactants expressed as active substance.

Disintegrators

In a preferred embodiment, the surfactant granules according to the invention may contain disintegrating agents (disintegrators). Disintegrators are substances which are present in the surfactant granules to accelerate their disintegration on contact with water. Disintegrators are reviewed, for example, in J. Pharm. Sci. 61 (1972) and in Römpp Chemielexikon, 9th Edition, Vol. 6, page 4440. Viewed macroscopically, the disintegrators may be homogeneously distributed in the granules although, when observed under a microscope, they form zones of increased concentration due to their production. Preferred disintegrators include polysaccharides, for example natural starch and derivatives thereof (carboxymethyl starch, starch glycolates in the form of their alkali metal salts, agar agar, guar gum, pectins, etc.), celluloses and derivatives thereof (carboxymethyl cellulose, microcrystalline cellulose), polyvinyl pyrrolidone, collodion, alginic acid and alkali metal salts thereof (alginates), amorphous or even partly crystalline layer silicates (bentonites), polyurethanes, polyethylene glycols and effervescent systems. Other disintegrators which may be present in accordance with the invention can be found, for example, in WO 98/40462 (Rettenmeyer), WO 98/55583 and WO 98/55590 (Unilever) and WO 98140463, DE 19709991 and DE 19710254 (Henkel). Reference is specifically made to the teaching of these documents.

To produce the granules according to the invention, the surfactants and disintegrators—based on their solids contents (pure substance content)—may be used in a ratio by weight of 1:10 to 10:1, preferably 1:5 to 5:1 and more particularly 1:2 to 2:1. In addition, it is advisable to adjust the water content of the disintegrators or the surfactant granules to such a value that they do not automatically begin to swell during storage. The residual water content should preferably be below 10% by weight.

Laundry Detergents, Dishwashing Detergents and Cleaners

The present invention also relates to laundry detergents, dishwashing detergents and cleaners containing the surfactant mixtures according to the invention. The detergents/cleaners may be present in the form of powders, granules, extrudates, agglomerates and, more particularly, tablets and may contain other typical ingredients which are described hereinafter under the heading “auxiliaries and additives”.

Enzymes

In addition, the surfactant granules according to the invention preferably contain enzymes. Suitable enzymes are, in particular, enzymes from the class of hydrolases, such as proteases, esterases, lipases or lipolytic enzymes, amylases, cellulases or other glycosyl hydrolases and mixtures thereof. All these hydrolases contribute to the removal of stains, such as protein-containing, fat-containing or starch-containing stains, and discoloration in the washing process. Cellulases and other glycosyl hydrolases can contribute towards color retention and towards increasing fabric softness by removing pilling and microfibrils. Oxidoreductases may also be used for bleaching and for inhibiting dye transfer. Enzymes obtained from bacterial strains or fungi, such as Bacillus subtilis, Bacillus licheniformis, Streptomyces griseus and Humicola insolens are particularly suitable. Proteases of the subtilisin type are preferably used, proteases obtained from Bacillus lentus being particularly preferred. Of particular interest in this regard are enzyme mixtures, for example of protease and amylase or protease and lipase or lipolytic enzymes or protease and cellulase or of cellulase and lipase or lipolytic enzymes or of protease, amylase and lipase or lipolytic enzymes or protease, lipase or lipolytic enzymes and cellulase, but especially protease- and/or lipase-containing mixtures or mixtures with lipolytic enzymes. Examples of such lipolytic enzymes are the known cutinases. Peroxidases or oxidases have also been successfully used in some cases. Suitable amylases include in particular α-amylases, isoamylases, pullanases and pectinases. Preferred cellulases are cellobiohydrolases, endoglucanases and β-glucosidases, which are also known as cellobiases, and mixtures thereof. Since the various cellulase types differ in their CMCase and avicelase activities, the desired activities can be established by mixing the cellulases in the appropriate ratios. The enzymes may be adsorbed to supports and/or encapsulated in membrane materials to protect them against premature decomposition. The percentage content of enzymes, enzyme mixtures or enzyme granules may be, for example, about 0.1 to 5% by weight and is preferably from 0.1 to about 2% by weight.

In addition to the monohydric and polyhydric alcohols, the detergents/cleaners may contain other enzyme stabilizers. For example, 0.5 to 1% by weight of sodium formate may be used. Proteases stabilized with soluble calcium salts and having a calcium content of preferably about 1.2% by weight, based on the enzyme, may also be used. Apart from calcium salts, magnesium salts also serve as stabilizers. However, it is of particular advantage to use boron compounds, for example boric acid, boron oxide, borax and other alkali metal borates, such as the salts of orthoboric acid (H₃BO₃), metaboric acid (HBO₂) and pyroboric acid (tetraboric acid H₂B₄O₇).

Proteins and Protein Derivatives

In addition, the detergents/cleaners may preferably contain proteins and protein derivatives which significantly improve the dissolving rate of the surfactant mixtures according to the invention. Reference is specifically made here to unpublished patent application DE 19956802 of which the disclosure is also being made part of the disclosure of the present invention.

The protein component is preferably formed by protein hydrolyzates and condensation products thereof with fatty acids and, to a lesser extent, by protein hydrolyzate esters and quaternized protein fatty acid condensates. Protein hydrolyzates are degradation products of animal or vegetable proteins, for example collagen, elastin or keratin, preferably almond and potato protein and more particularly wheat, rice and soya protein, which are obtained by acidic, alkaline and/or enzymatic hydrolysis and thereafter have an average molecular weight of 600 to 4,000 and preferably 2,000 to 3,500. Although protein hydrolyzates are not surfactants in the accepted sense because they lack a hydrophobic residue, they are often used for formulating surface-active compositions by virtue of their dispersing properties. Overviews of the production and use of protein hydrolyzates have been published, for example, by G. Schuster and A. Domsch in Seifen, Öle, Fette, Wachse, 108, 177 (1982) and Cosm. Toil. 99, 63 (1984), by H. W. Steisslinger in Parf. Kosm. 72, 556 (1991) and by F. Aurich et al. in Tens. Surf. Det. 29, 389 (1992). Vegetable protein hydrolyzates based on wheat gluten or rice protein, of which the production is described in German patents DE 19502167 C1 and DE 19502168 C1 (Henkel), are preferably used. So-called protein fatty acid condensates which are comparable in their properties with soaps can be obtained from the protein hydrolyzates by condensation with C₆₋₂₂, preferably C₁₂₋₁₈ fatty acids. Condensates of the above-mentioned hydrolyzates with caproic acid, caprylic acid, 2-ethyl hexanoic acid, capric acid, lauric acid, isotridecanoic acid, myristic acid, palmitic acid, palmitoleic acid, stearic acid, isostearic acid, oleic acid, elaidic acid, petroselic acid, linoleic acid, linolenic acid, elaeostearic acid, arachic acid, gadoleic acid, behenic acid and erucic acid are preferably used.

Granulation and Compacting

The present invention relates to a process for the production of surfactant granules in which fatty alcohol alkoxylates corresponding to formula (I) and anionic surfactants are granulated, optionally in the presence of other nonionic surfactants, enzymes and disintegrators, and optionally compacted.

The production of the surfactant granules, i.e. granulation and compacting, may be carried out by any of the methods known for detergents. In particular, the granules may be compacted before, during or after granulation. The granules are preferably compacted where disintegrators are present.

Fluidized Bed Granulation

A preferred process for the production of surfactant granules is fluidized bed granulation as already described in DE 19756681, the disclosure of DE 19756861 being made part of the disclosure of the present invention. Fluidized bed granulation is understood to be a simultaneous granulation and drying process preferably carried out in batches or continuously. The surfactants according to the invention and optionally enzymes, disintegrators and auxiliaries (perfumes, builders, defoamers, fillers, binders, plasticizers, lubricants, polymers, UV protection factors) may be used both in dried form and in the form of a water-containing or paste-like preparation. Auxiliaries in the context of the present invention also include those described in DE 10003124 of which the disclosure is being made part of the disclosure of the present invention.

Preferred fluidized-bed arrangements have base plates measuring 0.4 to 5 m. The granulation process is preferably carried out at fluidizing air flow rates of 1 to 8 m/s. The granules are preferably discharged from the fluidized bed via a sizing stage. Sizing may be carried out, for example, by means of a sieve or by an air stream flowing in countercurrent (sizing air) which is controlled in such a way that only particles beyond a certain size are removed from the fluidized bed while smaller particles are retained in the fluidized bed. The inflowing air is normally made up of the heated or unheated sizing air and the heated bottom air. The temperature of the bottom air is between 80 and 400° C. and preferably between 90 and 350° C. A starting material, preferably surfactant granules from an earlier test batch, is advantageously introduced at the beginning of the granulation process.

Another preferred process for the production of surfactant granules is spray drying in which the detergent ingredients are simultaneously sprayed, dried and granulated in a dryer.

Spray Drying

The dryer into which the aqueous preparation is sprayed can be any type of dryer. In one preferred embodiment of the process, drying is carried out by spray drying in a drying tower. In this case, the aqueous preparations are exposed in known manner to a stream of drying gas in fine-particle form. Applicants describe an embodiment of spray drying using superheated steam in a number of published patents. The operating principle disclosed in those publications is hereby specifically included as part of the disclosure of the present invention. Reference is made in particular to the following publications: DE 40 30 688 A1 and the further developments according to DE 42 04 035 A1; DE42 04 090 A1; DE 42 06 050 A1; DE 42 06 521 A1; DE 42 06 495 A1; DE 42 08 773 A1; DE 42 09 432 A1 and DE 42 34 376 A1. This process was introduced in connection with the production of the defoamer granules.

Drying and Granulation in a Thin Layer

Alternatively, the simultaneous drying and granulation process for producing surfactant granules may also be carried out in a horizontally arranged thin-layer evaporator with rotating internals of the type marketed, for example, by the VRV company under the name of “Flash Dryer”. In simple terms, the flash dryer is a tube which can be heated to different temperatures over several zones. The paste-form starting material, which is introduced by a pump, is projected onto the heated wall by one or more shafts fitted with paddles or plowshares as rotating internals and is dried on the heated wall in a thin layer typically with a thickness of 1 to 10 mm at temperatures of generally 100 to 200° C. The thin layer evaporator is operated with air in countercurrent (throughput 50 to 150 m³/h) under atmospheric conditions or reduced pressure. The gas entry temperature is generally in the range from 20 to 30° C. while the exit temperature is in the range from 100 to 130° C. The throughput is of course dependent on the size of the dryer but is typically between 5 and 15 kg/h. It is advisable to heat the pastes to 40-60° C. during their introduction into the dryer. In addition, after drying, it has proved to be of considerable advantage to transfer the granules, which are still at about 50 to 70° C., to a conveyor belt, preferably a vibrating chute or the like, and to cool them quickly, i.e. in 20 to 60 seconds, with ambient air to temperatures of about 30 to 40° C.

“Dropletization” Unit

Another preferred process for the production of surfactant granules is the formation of droplets (“dropletization”) using a vibrating casting plate which is already known for the processing of synthetic waxes, resins and low-viscosity polyesters. Corresponding units are marketed, for example, by Rieter-Automatik under the name of “Droppo Line” for use in the textile industry. Casting plates in the form of perforated disks are preferably used, the droplets passing through the bores into the spray tower. These perforated disks preferably have an output of 100 to 800 kg/h and more particularly of the order of 500 kg/h, the diameter of the perforations being between 0.5 mm (mean granule diameter 0.8 mm) and 1.4 mm (mean granule diameter 2.5 mm). The vibration frequency imposed on the water-containing surfactant preparations is typically in the range from 100 to 1,000 Hz and preferably in the range from 500 to 800 Hz. Another advantage over conventional processes is that only a light excess pressure (typically 10 to 100 mbar) need be applied. Basically, drying in the spray tower may be carried out with hot air or hot combustion gases flowing in countercurrent at temperatures of, for example, 100 to 150° C., as adequately described in the prior art. The granules are substantially spherical and have mean diameters of 1 to 2.5 mm, depending on the perforation diameter of the perforated plate and the vibration frequency. The dust content, i.e. particles smaller than 0.5 mm in size, is substantially zero.

In another preferred variant, particularly where detergents/cleaning compositions of high bulk density are to be obtained, the mixtures are subsequently subjected to a compacting step, optionally in the presence of other ingredients. In one preferred embodiment of the invention, the ingredients are compacted in a press agglomeration process. The press agglomeration process to which the solid premix is subjected may be carried out in various agglomerators. Press agglomeration processes are classified according to the type of agglomerator used. The four most common press agglomeration processes—which are preferred for the purposes of the invention—are extrusion, roll compacting, pelleting and tabletting, so that preferred agglomeration processes for the purposes of the present invention are extrusion, roll compacting, pelleting and tabletting processes.

One feature common to all these processes is that the premix is compacted and plasticized under pressure and the individual particles are pressed against one another with a reduction in porosity and adhere to one another. In all the processes (but with certain limitations in the case of tabletting), the tools may be heated to relatively high temperatures or may be cooled to dissipate the heat generated by shear forces.

In all the processes, one or more binders may be used as (a) compacting auxiliary(ies). However, it must be made clear at this juncture that, basically, several different binders and mixtures of various binders may also be used. A preferred embodiment of the invention is characterized by the use of a binder which is completely in the form of a melt at temperatures of only at most 130° C., preferably at most 100° C. and more preferably up to 90° C. In other words, the binder will be selected according to the process and the process conditions or, alternatively, the process conditions and, in particular, the process temperature will have to be adapted to the binder if it is desired to use a particular binder.

The actual compacting process is preferably carried out at processing temperatures which, at least in the compacting step, at least correspond to the temperature of the softening point if not to the temperature of the melting point of the binder. In one preferred embodiment of the invention, the process temperature is significantly above the melting point or above the temperature at which the binder is present as a melt. In a particularly preferred embodiment, however, the process temperature in the compacting step is no more than 20° C. above the melting temperature or the upper limit to the melting range of the binder. Although, technically, it is quite possible to adjust even higher temperatures, it has been found that a temperature difference in relation to the melting temperature or to the softening temperature of the binder of 20° C. is generally quite sufficient and even higher temperatures do not afford additional advantages. Accordingly it is particularly preferred, above all on energy grounds, to carry out the compacting step above, but as close as possible to, the melting point or rather to the upper temperature limit of the melting range of the binder. Controlling the temperature in this way has the further advantage that even heat-sensitive raw materials, for example peroxy bleaching agents, such as perborate and/or percarbonate, and also enzymes, can be processed increasingly without serious losses of active substance. The possibility of carefully controlling the temperature of the binder, particularly in the crucial compacting step, i.e. between mixing/homogenizing of the premix and shaping, enables the process to be carried out very favorably in terms of energy consumption and with no damaging effects on the heat-sensitive constituents of the premix because the premix is only briefly exposed to the relatively high temperatures. In preferred press agglomeration processes, the working tools of the press agglomerator (the screw(s) of the extruder, the roller(s) of the roll compactor and the pressure roller(s) the pellet press) have a temperature of at most 150° C., preferably of at most 100° C. and, in a particularly preferred embodiment, at most 75° C., the process temperature being 30° C. and, in a particularly preferred embodiment, at most 20° C. above the melting temperature or rather the upper temperature limit to the melting range of the binder. The heat exposure time in the compression zone of the press agglomerators is preferably at most 2 minutes and, more preferably, between 30 seconds and 1 minute.

To facilitate processing in the processes mentioned, it has proved to be of advantage to added granulation and compacting aids, for example polyethylene glycol waxes, to the surfactant granules in quantities of 1 to 10 and preferably 2 to 5% by weight, based on the granules. Granulation and compacting aids above all improve the surface-slip and adhesion behavior of the products and reduce the necessary energy input. If the desired particle size distribution is not achieved by compacting alone, other steps, for example grading, may be subsequently applied.

Preferred binders which may be used either individually or in the form of mixtures with other binders are polyethylene glycols, 1,2-polypropylene glycols and modified polyethylene glycols and polypropylene glycols. The modified polyalkylene glycols include, in particular, the sulfates and/or the disulfates of polyethylene glycols or polypropylene glycols with a relative molecular weight of 600 to 12,000 and, more particularly, in the range from 1,000 to 4,000. Another group consists of mono- and/or disuccinates of polyalkylene glycols which, in turn, have relative molecular weights of 600 to 6,000 and, preferably, in the range from 1,000 to 4,000. A more detailed description of the modified polyalkylene glycol ethers can be found in the disclosure of International patent application WO 93/02176. In the context of the present invention, polyethylene glycols include polymers which have been produced using C₃₋₅ glycols and also glycerol and mixtures thereof besides ethylene glycol as starting molecules. In addition, they also include ethoxylated derivatives, such as trimethylol propane (2-ethyl-2-hydroxymethyl-1,3-propanediol) containing 5 to 30 EO. The polyethylene glycols preferably used may have a linear or branched structure, linear polyethylene glycols being particularly preferred. Particularly preferred polyethylene glycols include those having relative molecular weights in the range from 2,000 to 12,000 and, advantageously, around 4,000. Polyethylene glycols with relative molecular weights below 3,500 and above 5,000 in particular may be used in combination with polyethylene glycols having a relative molecular weight of around 4,000. More than 50% by weight of such combinations may advantageously contain polyethylene glycols with a relative molecular weight of 3,500 to 5,000, based on the total quantity of polyethylene glycols. However, polyethylene glycols which, basically, are present as liquids at room temperature/1 bar pressure, above all polyethylene glycol with a relative molecular weight of 200, 400 and 600, may also be used as binders. However, these basically liquid polyethylene glycols should only be used in the form of a mixture with at least one other binder, this mixture again having to satisfy the requirements according to the invention, i.e. it must have a melting point or softening point at least above 45° C. Other suitable binders are low molecular weight polyvinyl pyrrolidones and derivatives thereof with relative molecular weights of up to at most 30,000. Relative molecular weight ranges of 3,000 to 30,000, for example around 10,000, are preferred. Polyvinyl pyrrolidones are preferably not used as sole binder, but in combination with other binders, more particularly in combination with polyethylene glycols.

Immediately after leaving the production unit, the compacted material preferably has temperatures of not more than 90° C., temperatures of 35 to 85° C. being particularly preferred. It has been found that exit temperatures—above all in the extrusion process—of 40 to 80° C., for example up to 70° C., are particularly advantageous.

Extrusion

In one preferred embodiment of the invention, the detergent according to the invention is produced by extrusion as described, for example in European patent EP 0 486 592 B1 or International patent applications WO 93/02176 and WO 94/09111 or WO 98/12299. In this extrusion process, a solid premix is extruded under pressure to form a strand and, after emerging from the multiple-bore extrusion die, the strands are cut into granules of predetermined size by means of a cutting unit. The solid, homogeneous premix contains a plasticizer and/or lubricant of which the effect is to soften the premix under the pressure applied or under the effect of specific energy, so that it can be extruded. Preferred plasticizers and/or lubricants are surfactants and/or polymers. Particulars of the actual extrusion process can be found in the above-cited patents and patent applications to which reference is hereby expressly made. In one preferred embodiment of the invention, the premix is delivered, preferably continuously, to a planetary roll extruder or to a twin-screw extruder with co-rotating or contra-rotating screws, of which the barrel and the extrusion/granulation head can be heated to the predetermined extrusion temperature. Under the shear effect of the extruder screws, the premix is compacted under a pressure of preferably at least 25 bar or—with extremely high throughputs—even lower, depending on the apparatus used, plasticized, extruded in the form of fine strands through the multiple-bore extrusion die in the extruder head and, finally, size-reduced by means of a rotating cutting blade, preferably into substantially spherical or cylindrical granules. The bore diameter of the multiple-bore extrusion die and the length to which the strands are cut are adapted to the selected granule size. In this embodiment, granules are produced in a substantially uniformly predeterminable particle size, the absolute particle sizes being adaptable to the particular application envisaged. In general, particle diameters of up to at most 0.8 cm are preferred. Important embodiments provide for the production of uniform granules in the millimeter range, for example in the range from 0.5 to 5 mm and more particularly in the range from about 0.8 to 3 mm. In one important embodiment, the length-to-diameter ratio of the primary granules is in the range from about 1:1 to about 3:1. In another preferred embodiment, the still plastic primary granules are subjected to another shaping process step in which edges present on the crude extrudate are rounded off so that, ultimately, spherical or substantially spherical extrudate granules can be obtained. If desired, small quantities of drying powder, for example zeolite powder, such as zeolite NaA powder, can be used in this step. This shaping step may be carried out in commercially available spheronizing machines. It is important in this regard to ensure that only small quantities of fines are formed in this stage. According to the present invention, drying—which is described as a preferred embodiment in the prior art documents cited above—may be carried out in a subsequent step but is not absolutely essential. It may even be preferred not to carry out drying after the compacting step. Alternatively, extrusion/compression steps may also be carried out in low-pressure extruders, in a Kahl press (manufacturer: Amandus Kahl) or in a so-called Bextruder (manufacturer: Bepex). In one particularly preferred embodiment of the invention, the temperature prevailing in the transition section of the screw, the pre-distributor and the extrusion die is controlled in such a way that the melting temperature of the binder or rather the upper limit to the melting range of the binder is at least reached and preferably exceeded. The temperature exposure time in the compression section of the extruder is preferably less than 2 minutes and, more particularly, between 30 seconds and 1 minute.

Roll Compacting

The surfactant granules according to the invention may also be produced by roll compacting. In this variant, the premix is introduced between two rollers—either smooth or provided with depressions of defined shape—and rolled under pressure between the two rollers to form a sheet-like compactate. The rollers exert a high linear pressure on the premix and may be additionally heated or cooled as required. Where smooth rollers are used, smooth untextured compactate sheets are obtained. By contrast, where textured rollers are used, correspondingly textured compactates, in which for example certain shapes can be imposed in advance on the subsequent detergent particles, can be produced. The sheet-like compactate is then broken up into smaller pieces by a chopping and size-reducing process and can thus be processed to granules which can be further refined and, more particularly, converted into a substantially spherical shape by further surface treatment processes known per se. In roll compacting, too, the temperature of the pressing tools, i.e. the rollers, is preferably at most 150° C., more preferably at most 100° C. and most preferably at most 75° C. Particularly preferred production processes based on roll compacting are carried out at temperatures 10° C. and, in particular, at most 50° C. above the melting temperature of the binder or the upper temperature limit of the melting range of the binder. The temperature exposure time in the compression section of the rollers—either smooth or provided with depressions of defined shape—is preferably at most 2 minutes and, more particularly, between 30 seconds and 1 minute.

Pelleting

The detergents according to the invention may also be produced by pelleting. In this process, the premix is applied to a perforated surface and is forced through the perforations and at the same time plasticized by a pressure roller. In conventional pellet presses, the premix is compacted under pressure, plasticized, forced through a perforated surface in the form of fine strands by means of a rotating roller and, finally, is size-reduced to granules by a cutting unit. The pressure roller and the perforated die may assume many different forms. For example, flat perforated plates are used, as are concave or convex ring dies through which the material is pressed by one or more pressure rollers. In perforated-plate presses, the pressure rollers may also be conical in shape. In ring die presses, the dies and pressure rollers may rotate in the same direction or in opposite directions. A press suitable for carrying out the process according to the invention is described, for example, in DE 38 16 842 A1. The ring die press disclosed in this document consists of a rotating ring die permeated by pressure bores and at least one pressure roller operatively connected to the inner surface thereof which presses the material delivered to the die space through the pressure bores into a discharge unit. The ring die and pressure roller are designed to be driven in the same direction which reduces the shear load applied to the premix and hence the increase in temperature which it undergoes. However, the pelleting process may of course also be carried out with heatable or coolable rollers to enable the premix to be adjusted to a required temperature. In pelleting, too, the temperature of the pressing tools, i.e. the pressure rollers, is preferably at most 150° C., more preferably at most 100° C. and most preferably at most 75° C. Particularly preferred production processes based on pelleting are carried out at temperatures 10° C. and, in particular, at most 5° C. above the melting temperature of the binder or the upper temperature limit of the melting range of the binder.

Commercial Applications

The present invention also relates to the use of the surfactant granules according to the invention in laundry/dishwashing detergents and cleaners for the home and the industrial and institutional sectors, the surfactant granules being present in the detergents/cleaners in quantities of 1 to 90, preferably 5 to 50 and more particularly 10 to 25% by weight, based on the detergent/cleaner The detergents/cleaners may be present both in the form of powders, compactates, supercompactates, pastes, blocks, granules, extrudates, agglomerates or in particular tablets and may contain other typical ingredients, as described in unpublished patent application DE 19962859. The disclosure of DE 19962859 is also being made part of the disclosure of the present invention. The laundry/dishwashing detergents/cleaners may be produced by the methods described for surfactant granules. The products in question are preferably heavy-duty detergents and light-duty detergents, wool and color detergents and speciality detergents, such as curtain detergents, but also cleaning compositions for hard surfaces, such as all-purpose cleaners, manual and machine dishwashing detergents, floor cleaners, bathroom cleaners, toilet cleaners, interior/exterior car cleaners and solid cleaners.

“Solid cleaners” are understood to be cleaners which are used in solid form, preferably in the form of blocks, for example as soap bars. Block cleaners may also be used in special dosing units for the preparation of individual cleaning mixtures. In this application, material is eroded from the block and mixed in the desired ratio with auxiliaries and solvent, for example water.

Accordingly, the present invention also relates to the use of the surfactant granules according to the invention in detergent compactates, liquid and gel-form detergents, laundry/dishwashing detergent tablets, cleaning tablets and solid cleaners.

### EXAMPLES

The two granular surfactants according to the invention H1 (oleyl alcohol+8EO/dodecyl benzenesulfonate sodium salt=1:2) and H2 (oleyl alcohol+8EO/lauryl alcohol sulfate sodium salt=1:2) and two commercially available granular surfactants (H3=coconut fatty alcohol+7EO/dodecyl benzenesulfonate sodium salt, H4=coconut fatty alcohol+7EO/lauryl alcohol sulfate sodium salt) were used in detergent formulations. To determine solubility, quantities of 20 g of washing powder were added with continuous stirring to 1 liter of water at 15° C. The solution was filtered through a sieve (mesh width 0.1 mm) after 60 s (T1), 120 s (T2) and 300 s (T3). The filter residue was dried in air for one hour and weighed. The results are set out in Table 1.

The detergent formulations were all similarly tabletted after addition of 7 g of microcrystalline compacted cellulose (tablet weight 40 g, constant fracture hardness). The tablets obtained were hermetically packed and then stored for 2 weeks at 40° C. To evaluate dissolving behavior, the tablets were placed on a wire rack standing in water (0° d, 25° C.). The tablets were completely surrounded by water. The disintegration time from immersion to complete dissolution was measured. The disintegration times are also shown in Table 1.

TABLE 1
Compositions and dissolving rates (quantities in % by weight)

| Composition/performance | 1 | 2 | 3 | C1 | C2 |
|---|---|---|---|---|---|
| Granules H1 | 10.0 | — | — | — | — |
| Granules H3 | — | — | — | 10.0 | — |
| Granules H2 | — | 10.0 | 10.0 | — | — |
| Granules H4 | — | — | — | — | 10.0 |
| Coconut alcohol + 7EO | 6.0 | 6.0 | — | 6.0 | 6.0 |
| C_{12/18} coconut alkyl polyglucoside | — | — | 6.0 | — | — |
| Palm kernel oil fatty acid sodium | 2.0 | 2.0 | 2.0 | 2.0 | 2.0 |
| salt | | | | | |
| Sodium silicate | 2.0 | 2.0 | 2.0 | 2.0 | 2.0 |
| Sodium carbonate | 13.0 | 13.0 | 13.0 | 13.0 | 13.0 |
| Zeolite A | 26.0 | 26.0 | 26.0 | 26.0 | 26.0 |
| Polycarboxylate | 3.0 | 3.0 | 3.0 | 3.0 | 3.0 |
| Sodium percarbonate | 15.0 | 15.0 | 15.0 | 15.0 | 15.0 |
| Silicone defoamer | 2.0 | 2.0 | 2.0 | 2.0 | 2.0 |
| TAED | 4.0 | 4.0 | 4.0 | 4.0 | 4.0 |
| CMC | 2.0 | 4.0 | 4.0 | 4.0 | 4.0 |

| | |
|---|---|
| Sodium sulfate, water | to 100 |

Residual quantity of washing powder [g]

| | | | | | |
|---|---|---|---|---|---|
| T0 | 20.0 | 21.0 | 20.0 | 20.0 | 20.0 |
| T1 | 13.0 | 14.0 | 14.0 | 19.0 | 19.0 |
| T2 | 8.0 | 8.0 | 8.0 | 16.0 | 15.0 |
| T3 | — | — | | 5.0 | 5.0 |
| Disintegration time, tablets [s] | 35 | 33 | 33 | >200 | 170 |

1. Surfactant granules containing
a. fatty alcohol alkoxylates corresponding to formula (I) based on vegetable unsaturated fatty alcohols with iodine values of 20 to 130 and a conjuene content of less than 4.5%:
R¹—O(CH₂R²CHO)ₓ—H (I)
in which
R¹ is an alkenyl group containing 6 to 22 carbon atoms.
R² is hydrogen or a methyl or ethyl group and
x has a value of 1 to 50, and
b. anionic surfactants.

2. Surfactant granules as claimed in claim 1, characterized in that they contain anionic surfactants selected from the group consisting of alkyl and/or alkenyl sulfates, alkyl ether sulfates, alkyl benzenesulfonates, soaps, monoglyceride (ether) sulfates and alkanesulfonates.

3. Surfactant granules as claimed in claim 1, characterized in that they contain fatty alcohol alkoxylates of formula (I) and anionic surfactants in a ratio by weight of 1:90 to 90:1.

4. Surfactant granules as claimed in claim 1, characterized in that fatty alcohol alkoxylates of formula (I) and anionic surfactants expressed as active substance are present in quantities of 0.1 to 89% by weight, based on the granules.

5. Surfactant granules as claimed in claim 1, characterized in that they contain fatty alcohol alkoxylates corresponding to formula (I) obtainable by pressure hydrolysis of vegetable fats and oils into fatty acids or by subsequent esterification or direct transesterification with methanol into the fatty acid methyl esters and subsequent selective hydrogenation to fatty alcohols with the double bonds intact and subsequent alkoxylation, preferably ethoxylation.

6. Surfactant granules as claimed in any of claims 1 to 5, characterized in that they contain other nonionic surfactants selected from the group consisting of alkyl and/or alkenyl oligoglycosides, hydroxy mixed ethers, alkoxylates of alkanols, end-capped alkoxylates of alkanols, fatty acid lower alkyl esters and amine oxides.

7. Surfactant granules as claimed in any of claims 1 to 6, characterized in that they additionally contain disintegrators.

8. Surfactant granules obtainable by subjecting fatty alcohol alkoxylates corresponding to formula (I) and anionic surfactants to granulation, optionally in the presence of other nonionic surfactants, enzymes and disintegrators, and optionally compaction.

9. A process for the production of surfactant granules in which fatty alcohol alkoxylates corresponding to formula (I) and anionic surfactants are granulated, optionally in the presence of other nonionic surfactants, enzymes and disintegrators, and optionally compacted.

10. A process for the production of the surfactant granules claimed in claim 7, characterized in that the granules are compacted before, during or after granulation.

11. A process for the production of the surfactant granules claimed in claims 1 to 8, characterized in that they are produced by fluidized bed granulation and optionally compacted.

12. A process for the production of the surfactant granules claimed in claims 1 to 8, characterized in that they are produced by spray drying, the detergent ingredients being simultaneously sprayed, dried and granulated in a dryer and optionally compacted.

13. The use of the surfactant granules claimed in claims 1 to 8 in laundry detergents, dishwashing detergents and cleaners.

14. The use of the surfactant granules claimed in claims 1 to 8 in detergent compactates, liquid and gel-form detergents, laundry/dishwashing detergent tablets and cleaning tablets and solid cleaners.
